(19) United States
(12) Patent Application Publication
(10) Pub. No.: US 2003/0110361 A1
(43) Pub. Date: Jun. 12, 2003

(54) Nonvolatile memory

(75) Inventors: Akira Kanehira, Tokyo (JP); Hiroyuki Uchida, Koganei (JP); Shinichi Kurogochi, Fussa (JP); Yoshikazu Iida, Higashimurayama (JP)

Correspondence Address: MILES & STOCKBRIDGE PC, 1751 PINNACLE DRIVE, SUITE 500, MCLEAN, VA, 22102-3833, US

(73) Assignees: Hitachi, Ltd.; Hitachi ULSI Systems Co., Ltd.

(21) Appl. No.: 10/270,590

(22) Filed: Oct. 16, 2002

(30) Foreign Application Priority Data
Oct. 31, 2001 (JP) 2001-334243

(51) Int. Cl. G06F 12/00

(52) U.S. Cl. 711/154; 711/173

(57) ABSTRACT

A nonvolatile memory is configured inclusive of a memory unit including a data area capable of writing data therein, and a management area capable of writing therein management information about the data written into the data area, and a memory control unit for controlling the operation of the memory unit. Under such a configuration, there is provided control means for instructing rewriting of next data with respect to a write error produced in the data area without instructing rewriting of the same data, and instructing rewriting of the same data with respect to a write error produced in the management area. Owing to its provision, an effective record rate can be avoided from falling below a rate for write data.

### BACKGROUND OF THE INVENTION

The present invention relates to a nonvolatile memory, and to a technology effective for application to a nonvolatile memory including a flash memory, for example.

A flash memory illustrative of one example of nonvolatile memories is capable of rewriting information according to electrical erasing/writing. Each memory cell thereof can be made up of one transistor in a manner similar to an EPROM (Electrically Programmable Read Only Memory). The flash memory has the function of electrically erasing all the memory cells or blocks of the memory cells collectively. As a recording medium employed in a nonvolatile memory shaped in a card form, there is known one that provides a flash memory. For example, a JEIDA memory card (Type I), i.e., a memory card having an interface adapted to a JEIDA memory card interface is illustrated as one example. This type of memory card has a local memory and a card controller both of which are connected by a local bus, and are formed on a card substrate as a whole. The local memory comprises flash memories each having a storage capacity of a few megabits and arranged in plural form. The card controller controls the flash memories through the interface adapted to the JEIDA.

U.S. Pat. No. 5,844,842 has described a batch-erase type EEPROM (Electrically Erasable and Programmable Read-Only Memory). The batch-erase type EEPROM can be grasped as equivalent to a flash memory described in the present specification.

### SUMMARY OF THE INVENTION

As a medium for recording motion picture data in a video camera, a flash memory card can be adopted. Since the motion picture data is important in real-time property, the writing of the motion picture into the flash memory card must be smoothly performed. The recording medium in which emphasis is placed on the real-time property as in the case of the motion picture data in the video camera, needs to assure a minimum write time so as to avoid a failure in system. According to discussions of the inventors of the present application, it has been found out that when data like the motion picture data, which gives priority to the real-time property, is written into the flash memory card, the system breaks down even if an average write speed is more than or equal to a rate for write data. When the time necessary for writing to a given sector exceeds a predetermined time interval due to the occurrence of rewriting of the same data and the like due to the generation of a write error, despite of the fact that the average write speed is the write data rate or more, for example, an effective record rate in the system will fall below the rate for the write data. As a result, the system is considered to break down.

An object of the present invention is to provide a technology for avoiding a failure in system due to the fact that an effective record rate employed in the system falls below a rate for write data.

The above, other objects and novel features of the present invention will become apparent from the description of the present specification and the accompanying drawings.

Summaries of typical ones of the inventions disclosed in the present application will be described in brief as follows:

[1] When a nonvolatile memory is configured inclusive of a memory unit including a data area capable of writing data therein and a management area capable of writing therein management information about the data written into the data area, and a memory control unit for controlling the operation of the memory unit, control means is provided for instructing writing of next data with respect to a write error produced in the data area without instructing rewriting of the same data and for instructing rewriting of the same data with respect to a write error produced in the management area. The term “write error” described herein means that write data cannot be correctly written. The term “rewriting” means that the same data is written again and includes both wiring to an area in which a write error has occurred, and writing to different areas.

According to the above means, the writing of next data is instructed with respect to the write error produced in the data area without instructing the rewriting of the same data to thereby assure a write speed of a predetermined rate or more, whereby an effective record rate is avoided from falling below a rate for write data. By instructing the rewriting of the same data with respect to the write error produced in the management area, the accuracy for performing data writing is assured in the management area. Even if a slight data error occurs in the case of such motion picture data that emphasis is placed on a real-time property, for example, it is not affected so much by the data error in terms of the property of motion pictures. Therefore, the rewriting of the same data is omitted as to data in which emphasis is placed on a real-time property, to thereby avoid that an effective record rate falls below a rate for write data, whereby a failure in system can be prevented from occurring.

[2] As a further specific aspect, when a nonvolatile memory is configured inclusive of a memory unit including a data area capable of writing data therein, and a management area capable of writing therein management information about the data written into the data area, a memory controller capable of issuing various commands related to the operation of the memory unit, and a memory control unit for controlling the operation of the memory unit in accordance with a command issued from the memory controller, the memory control unit may be configured so as to transmit error information to the memory controller without rewriting when an error occurs upon the writing to the memory unit. Further, the memory controller may be configured so as to control writing of next data without rewriting of the same data when a write operation at the transmission of error information from the memory control unit is intended for the data area and to control rewriting of the same data when the write operation at the transmission of the error information from the memory control unit is intended for the management area.

According to the above means, the main controller controls the writing of the next data without performing the rewiring of the same data when the write operation at the transmission of the error information from the memory control unit is intended for the data area and controls the rewriting of the same data when the write operation at the transmission of the error information from the memory control unit is intended for the management area. Owing to such control, the writing of the next data is instructed to the write error in the data area without instructing the rewriting of the same data to thereby assure a write speed of a predetermined rate or more, whereby an effective record rate can be avoided from falling below a rate for write data. Instructing the rewriting of the same data with respect to the write error produced in the management area makes it possible to assure the accuracy for performing data writing in the management area.

[3] Since, at this time, such a process as to give priority to a real-time property of data and inhibit the real-time property thereof is omitted as far as practicable, the controller is capable of omitting the addition of a code for correcting an error of data to be written into the data area to the same data and adding a code for correcting an error of data to be written into the management area to the same data.

[4] The memory controller can be configured so as to issue a first command for specifying a first write mode accompanied by rewriting of the same data upon the writing to the management area and issue a second command for specifying a second write mode free of rewriting of the same data upon the writing to the data area. Further, the memory controller can be configured so as not to effect rewriting of the same data on a write error in a specified state of the second write mode by the second command and so as to effect rewriting of the same data on a write error in a specified state of the first write mode by the first command.

According to the above means, write control based on the second write mode is instructed to the memory control unit in the case of the writing to the data area, whereas in the case of the writing to the management area, write control based on the first write mode is instructed to the memory control unit. This assures a write speed of a predetermined rate or more, so that an effective record rate is avoided from falling below a rate for write data. By instructing the rewriting of the same data with respect to the write error in the management area, the accuracy for performing data writing is assured in the management area.

[5] Since, at this time, such a process as to give priority to a real-time property of data and inhibit the real-time property is omitted as far as practicable, the controller can be configured so as to omit the addition of a code for correcting an error of data to be written into the data area to the same data and add a code for correcting an error of data to be written into the management area to the same data.

[6] The instructions for the write control in the first write mode and the instructions for the write control in the second write mode can be supplied to the memory control unit via a terminal for enabling capturing of write addresses and write data according to predetermined commands, in advance of the write addresses and write data in order to smooth a process based on such instructions as referred to above.

[7] Even in the case where the first write mode and the second write mode are included, such a process as to give priority to a real-time property of data and inhibit the real-time property is omitted where practicable in the memory control unit. Therefore, the addition of a code for correcting an error of data to be written into the data area to the same data can be omitted, and a code for correcting an error of data to be written into the management area can be added to the same data.

[8] The data written into the data area can be used as motion picture data or voice data. In such a case, the writing of next data is instructed with respect to a write error in the data area without instructing rewriting of the same data to thereby make it possible to assure a write speed greater than or equal to a predetermined rate. Therefore, motion picture data or voice data can be recorded satisfactorily.

### BRIEF DESCRIPTION OF THE DRAWINGS

FIG. 1 is a block diagram illustrating a configurational example of a main part of a data recording system which is illustrative of one example of a nonvolatile memory according to the present invention;

FIG. 2 is a block diagram showing a configurational example of the data recording system;

FIG. 3 is a block diagram depicting another configurational example of the data recording system;

FIG. 4 is an explanatory view showing writing to a management area in the data recording system;

FIG. 5 is an explanatory view illustrating writing to a data area in the data recording system;

FIG. 6 is an operation timing chart for describing the writing to the management area in the data recording system;

FIG. 7 is an operation timing chart for describing the writing to the data area in the data recording system;

FIG. 8 is another explanatory view showing the writing to the management area in the data recording system;

FIG. 9 is another explanatory view illustrating the writing to the data area in the data recording system;

FIG. 10 is another operation timing chart showing the writing to the management area in the data recording system;

FIG. 11 is another operation timing chart illustrating the writing to the data area in the data recording system; and

FIG. 12 is an explanatory view showing a format example of a flash memory system included in the data recording system.

### DETAILED DESCRIPTION OF THE PREFERRED EMBODIMENTS

A configurational example of a data recording system showing one example of a nonvolatile memory according to the present invention is shown in FIG. 2.

The data recording system 101 shown in FIG. 2 is capable of recording such data that a real-time property is given a priority. Although not restricted in particular, an interface controller 2, a buffer memory 3, a controller 4, and an input unit 5 are coupled to one another by a bus 100 so that the transfer of signals therebetween is enabled. A flash memory system 1 is provided as a recording medium of the data that gives priority to the real-time property. The interface controller 2 is interposed between the flash memory system 1 and the bus 100 and performs control on the interface between the flash memory system 1 and a system equipped therewith. The flash memory system 1 is one example of nonvolatile memory systems. Although not restricted in particular, it is shaped in the form of a card and detachably mounted to the data recording system 101. Although not restricted in particular, the control effected on the flash memory system 1 is based upon the protocol of “The Multi Media Card System Specification Version 3.1”.

The buffer memory 3 has a relatively small storage capacity and is used to temporarily store data to be written into the flash memory system 1. Although not restricted in particular, the controller 4 serves as a microcomputer and controls the operation of the whole data recording system 101 according to a preset program. The input unit 5 makes it possible to take or capture such data as to give priority to a real-time property, such as motion picture data, voice data, etc.

The motion picture data and voice data captured via the input unit 5 are stored in the buffer memory 3 and thereafter written into the flash memory system 1 under the control of the interface controller 2. The data written into the flash memory system 1 can be read as needed.

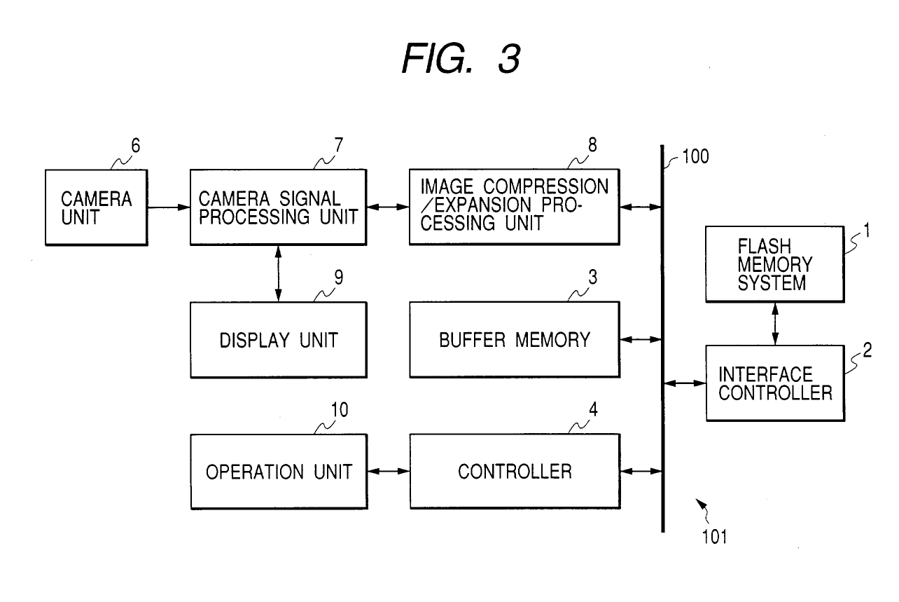

Another configurational example of the data recording system 101 is shown in FIG. 3.

The data recording system 101 shown in FIG. 3 is much different from the system shown in FIG. 2 in that it has a camera unit 6, a camera signal processing unit 7, an image compression/expansion processing unit 8, a display unit 9 and an operation unit 10.

The camera unit 6 is one for imaging motion pictures and includes a fixed imaging device such as an optical system, CCD (Charge Coupled Device) or the like. The camera signal processing unit 7 includes an A/D (Analog/Digital) converter for converting a video signal outputted from the fixed imaging device into a digital signal, a DSP (Digital Signal Processor) for effecting various image processing such as a γ correction, etc. on the digital signal outputted from the A/D converter, etc. The image compression/expansion processing unit 8 has the function of compressing a vide signal transmitted from the cameral signal processing unit 7 into an MPEG format and expanding the compressed video signal. The compressed data is written into the flash memory system via the buffer memory 3 under the control of the interface controller 2. The display unit 9 has a liquid crystal display panel for displaying the video signal transferred from the camera signal processing unit 7. The operation unit 10 includes various switches for operating the data recording system 101. The compressed data written into the flash memory system 1 is read as needed and expanded by the image compression/expansion processing unit 8, after which it can be displayed on the display unit 9 via the camera signal processing unit 7.

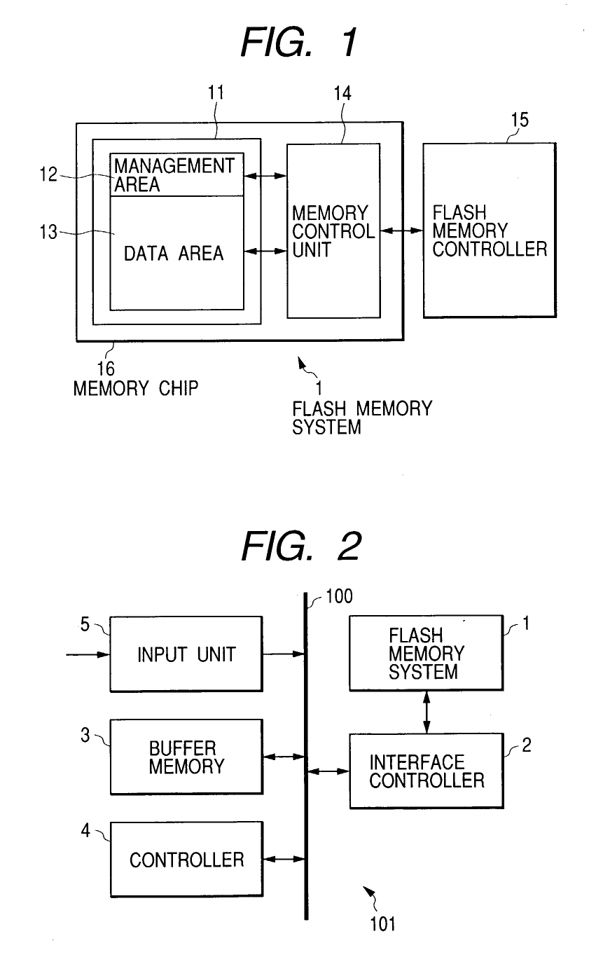

A configurational example of the flash memory system 1 shown in FIGS. 2 and 3 is shown in FIG. 1.

Although not restricted in particular, the flash memory system 1 includes a memory chip 16, and a flash memory controller 15 for controlling the operation of the memory chip 16 and is formed in a card fashion.

The memory chip 16 includes a memory unit 11 comprising a plurality of flash memory cells arranged in an array form, and a memory control unit 14 for controlling the operation of the memory unit 11 according to various commands sent from the flash memory controller 15. Although not restricted in particular, the memory unit 11 includes a management area 12 and a data area 13. Management information about data written into the data area 13 is written into the management area 12. Although not restricted in particular, data giving priority to a real-time property like motion pictures, voice data or the like is written into the data area 13.

Although not restricted in particular, the memory chip 16 is provided with an input/output terminal I/O for taking in or capturing various commands, write addresses, write data, status information, etc. and allowing read data to be outputted, a write enable signal input terminal for capturing a write enable signal/WE indicative of the effectivity of writing, a serial clock input terminal for taking in a serial clock signal SC, an output enable signal input terminal for capturing an output enable signal/OE indicative of the effectivity of output data, and an output terminal for a ready/busy signal R/B, for notifying to the outside of the chip whether the memory chip 16 is in a ready state or a busy state.

The various commands given from the flash memory controller 15 to the memory control unit 14 include a write command for giving instructions as to writing of data into the memory unit 11, a command for giving instructions as to write verify, a read command for giving instructions as to reading of data from the memory unit 11, an erase command for erasing the data stored in the memory unit 11, etc.

In response to a command or other control signals outputted from the flash memory controller 15, the memory control unit 14 controls various internal operations such as read, erase and write operations, write verify, etc. of the memory unit 14 according to programs stored in an internal read-only memory. While instructions as to the write operation, for example, is carried out according to a predetermined command, the erase operation of the flash memory cell and the operation of writing of write data therein are controlled as a series of operations at this time. Namely, when the write operation is designated without the erase operation instructions and write operation instructions being given individually, the erase operation of the flash memory cell array is first carried out based on the instructions for the write operation, and thereafter the writing of data therein is done.

The erase operation includes a verify operation for determining whether an erase state is proper. With the completion of the erase operation, the write data is written into the memory unit 11. During a period in which the write data is written into the memory unit 11, the memory control unit 14 brings a read/busy signal R/B indicative of “during the data write operation” to a low level and notifies to the flash memory controller 15 that the memory unit 11 is in data write operation at present. The period in which the ready/busy signal R/B* is high in level, indicates that the writing of data is enabled. The write operation includes a verify operation for discriminating whether a write state is proper.

While the memory unit is in data write operation during the period in which the ready/busy signal R/B is low in level, the memory control unit 14 determines during the data write operation whether the data writing corresponding to the write command is properly performed. The result of its determination is reflected on a status signal read by the flash memory controller 15. When an error occurs upon the writing to the memory unit 11, the memory control unit 14 transmits error information to the interface controller 2 without rewriting of the same data therein. Although not restricted in particular, the error information is transferred to the flash memory controller 15 according to predetermined bits of the status signal outputted after the ready/busy signal R/B* has been transitioned from the low level to the high level and the write operation has been completed.

The flash memory controller 15 performs the conversion of a memory logical address received via the bus 100 to a physical address and issues various commands and various control signals to the memory control unit 14. When the write operation to be executed when the error information is transmitted from the memory control unit 4, is intended for the data area 13, the flash memory controller 15 controls the writing of next data therein without rewriting the same data therein, whereas when the write operation to be executed when the error information is transmitted from the memory control unit 14, is intended for the management area 12, the flash memory controller 15 controls the rewriting of the same data. Namely, if the rewriting of the same data is done where the write operation at the transmission of the error information from the memory control unit 14 is intended for the data area 13, there is a possibility that an effective record rate employed in the system will fall below a rate for write data. In order to avoid it, the flash memory controller 15 gives priority to the realtime property and proceeds to the write operation of next data without perfectly performing the rewriting of the data related to the error where the write operation at the transmission of the error information therefrom is intended for the data area 13. On the other hand, when the write operation at the transmission of the error information from the memory control unit 14 is intended for the management area 12, the flash memory controller 15 rewrites data about an error to assure writing accuracy. Here, the flash memory controller 15 is defined as one example of control means according to the present invention.

In order to omit such a process as to inhibit the real-time property of data where practicable, the flash memory controller 15 omits the addition of a code used for correcting an error of data to be written into the data area 13 to the data. Data to be written into the management area 12 is added with a code for correcting an error produced in the data with the reliability of the data being given priority. Although not restricted in particular, the error correcting code is set as ECC (error checking and correcting) herein, and a 1-bit error automatic correction and a 2-bit error detection are enabled. Adding such an ECC code to the data and writing it make it possible to correct an error produced upon reading the data.

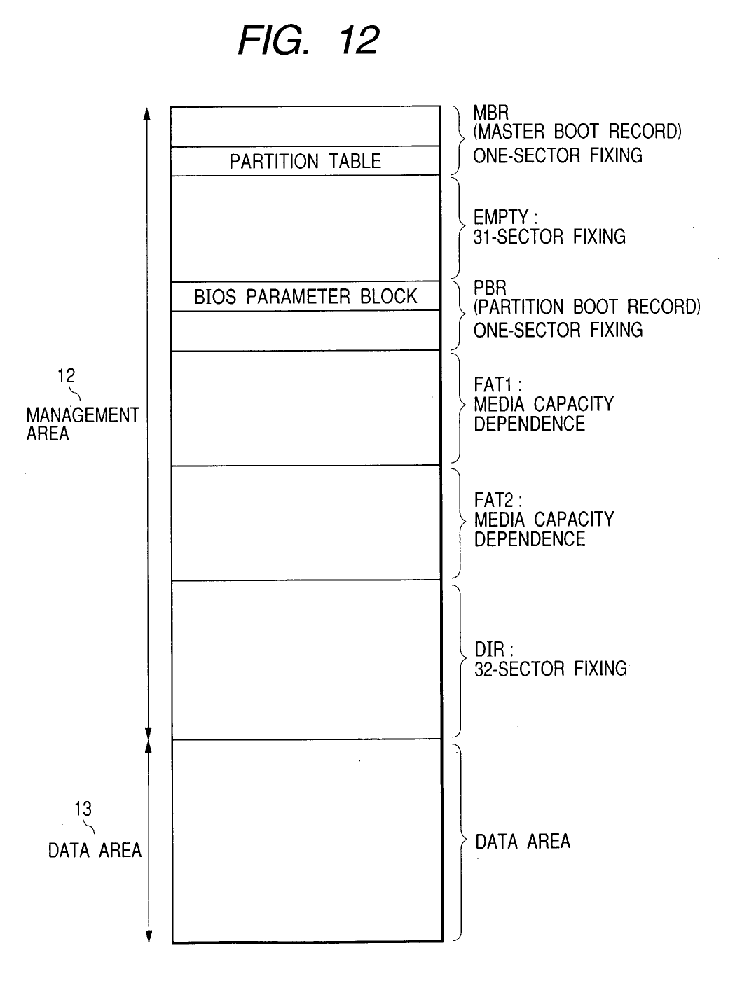

FIG. 12 shows an example of a format employed in the flash memory system 1. It is formed upon formatting where a FAT file system is used. A management area 12 and a data area 13 are arranged in a logical address order.

The management area 12 is assigned an MBR (Master Boot Record), a free space, a PBR (Partition Boot Record), a FAT1 (media capacity dependence), a FAT2 (media capacity dependence), and a DIR (32-sector fixing) in that order. The master boot record and the partition boot record are both configured as one-sector fixing and respectively include a partition table and a BIOS parameter block. After the formatting, the flash memory controller 15 confirms logical addresses for the management area 12 and the data area 13, based on data on the master boot record and the partition boot record, for example.

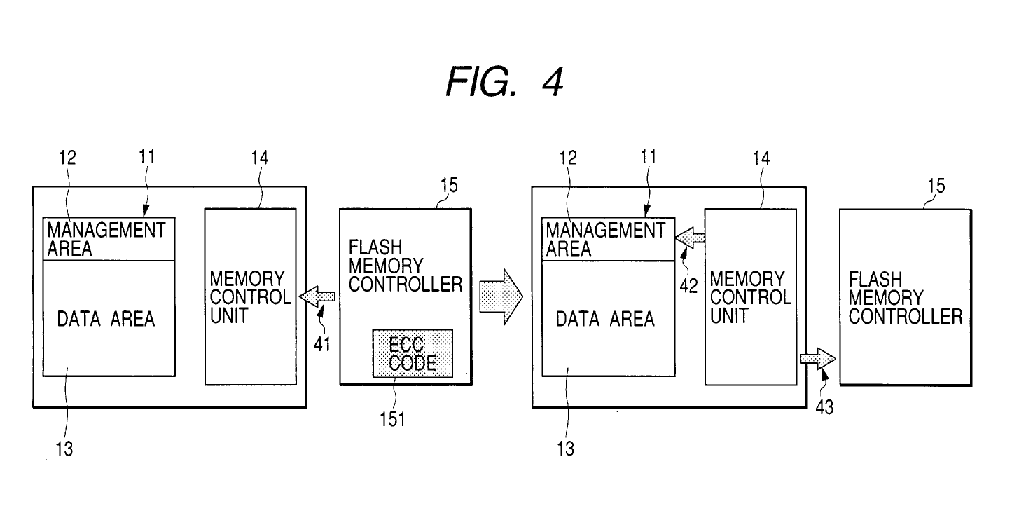

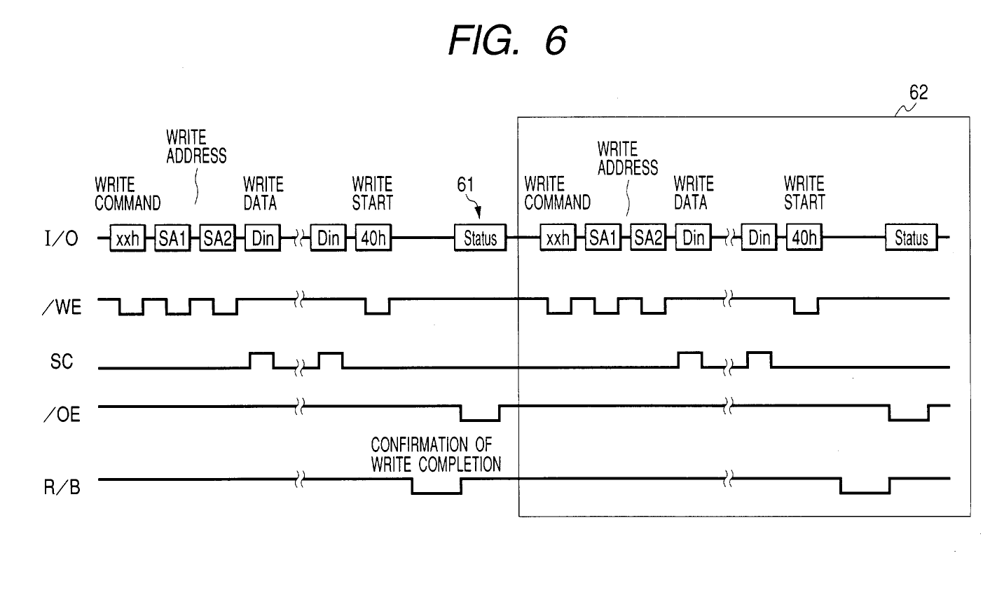

The operation of writing of data into the management area 12 is shown in FIG. 4, and operating timings of major parts at the write operation are illustrated in FIG. 6.

When management information is written into the management area 12, the flash memory controller 15 generates an ECC code 151 and issues an access command to the memory control unit 14 so that data is written into the management area together with the code (41). Upon the writing to the management area 12, a write command xxh, write addresses SA1 and SA2, write data Din and a write start command 40h are sequentially transmitted to an input/output terminal I/O of the flash memory system 1 from the flash memory controller 15 as shown in FIG. 6. The write address SA1 is set as a row address signal of the memory unit 1. The write address SA2 inputted following it is set as a column address signal of the memory unit 1. The write address SA2 is set as an initial address for memory access, and an address following it is generated by the memory control unit 14 in synchronism with a serial clock signal SC transmitted from the flash memory controller 15. The write data Din transmitted to the input/output terminal I/O is taken in or brought to the memory control unit 14 in synchronism with the serial clock signal SC. Writing is started in response to the write start command 40h. The writing of the data into the management area 12 is performed during a period-in which a ready/busy signal R/B is low in level. After the confirmation of the write completion, an output enable signal/OE is asserted low in level by the flash memory controller 15, so that status information Status is outputted from the input/output terminal I/O (43). The flash memory controller 15 checks for the logic of a predetermined bit in the status information Status to thereby enable determination as to whether a write error has occurred upon the writing of the write data Din. When the logic of the predetermined bit in the status information Status is rendered low in level, for example, it indicates that the writing has been normally carried out. When the logic is rendered high in level, it indicates that the writing has not been normally performed.

Even when the write error has occurred, the memory control unit 14 does not rewrite the same data (42) but transmits error information indicative of the occurrence of the error to the flash memory controller 15 according to the predetermined bit in the status information Status (43). When the write operation at the transmission of the error information from the memory control unit 14 is intended for the management area 12, the flash memory controller 15 instructs the memory control unit 14 to rewrite the same data. Namely, a write command xxh, write addresses SA1 and SA2, write data Din and a write start command 40h are sequentially transferred to the input/output terminal I/O of the flash memory system 1 again from the flash memory controller 15 as designated at numeral 62 in FIG. 6, whereby rewriting is done (62). Even upon such rewriting, error discrimination based on status information Status is made. When the error occurs, the rewriting (62) is performed again. When the error occurs many times, the conversion of the write address into another is performed such that the writing of data into an alternative area preset to the management area 12 is carried out.

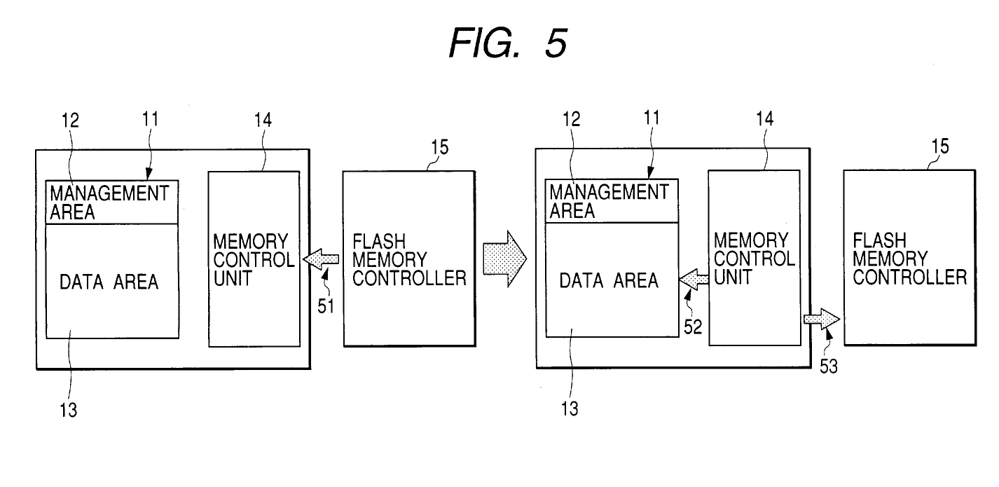

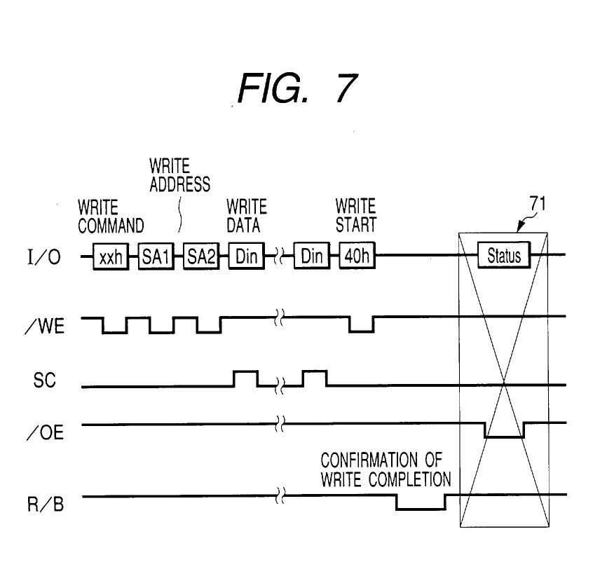

The operation of writing to the data area 13 is shown in FIG. 5, and operating timings of major parts at the write operation are illustrated in FIG. 7.

When data is written into the data area 13, the flash memory controller 15 issues an access command to the memory control unit 14 so as to write the data into the data area 13 (51). At this time, the flash memory controller 15 does not generate the ECC code 151. This is because where the data is written into the data area 13, such a process as to give priority to a real-time property of the data and inhibit the real-time property thereof is omitted as far as practicable.

Upon the writing to the data area 13, a write command xxh, write addresses SA1 and SA2, write data Din, and a write start command 40h are sequentially transmitted from the flash memory controller 15 to the input/output terminal I/O of the flash memory system 1 as shown in FIG. 7. The write address SA1 is set as a row address signal of the memory unit 1, and the write address SA2 inputted following it is set as a column address signal of the memory unit 1. The write address SA2 is set as an initial address for memory access, and an address following it is generated by the memory control unit 14 in synchronism with a serial clock signal SC transmitted from the flash memory controller 15. The write data Din transmitted to the input/output terminal I/O is brought to the memory control unit 14 in synchronism with the serial clock signal SC. Further, the writing is done in response to the write start command 40h. The writing of data into the management area 12 is performed during a period in which a ready/busy signal R/B is low in level. While the logic of the predetermined bit in the write status information Status is checked after the confirmation of the write completion to thereby discriminate whether the write error has occurred, upon the writing to the management area 12 (see FIGS. 4 and 6), the writing is completed without making the error discrimination based on the status information Status upon the writing to the data area 13 (71). Namely, neither of rewriting (52) by the memory control unit 14 nor transmission (53) of error information from the memory control unit 14 to the flash memory controller 15 is done. This is done to omit such a process as to give priority to a real-time property of the data written into the data area 13 and inhibit the real-time property thereof as far as practicable.

According to the above-described example, the following operations and effects can be obtained.

(1) The memory control unit 14 sends error information to the interface controller without performing rewriting where an error occurs upon the writing to the memory unit 1. The interface controller 2 controls the writing of next data into the data area 11 without rewriting the same data where a write operation at the transmission of the error information from the memory control unit 14 is intended for the data area 11. When the write operation at the transmission of the error information from the memory control unit 14 is intended for the management area 12, the interface controller 2 is configured inclusive of the controller 15 for controlling the rewriting of the same data. Thus, when the write operation at the transmission of the error information from the memory control unit 14 is intended for the data area, the interface controller 2 is controlled so as to write the next data therein without rewriting the same data. When the write operation at the transmission of the error information from the memory control unit 14 is intended for the management area, the interface controller 2 controls the rewriting of the same data. Owing to such control as referred to above, the writing of next data is instructed with respect to a write error produced in the data area without instructing the rewriting of the same data to thereby assure a write speed of a predetermined rate or more, whereby an effective record rate can be avoided from falling below a rate for write data. Instructing the rewriting of the same data with respect to a write error produced in the management area makes it possible to assure the accuracy for performing data writing in the management area.

(2) As to data to be written into the data area, the addition of a code used for correcting an error of the data to the same data is omitted therefrom in the flash memory controller 15. Further, such a process as to add a code for correcting an error of data to be written into the management area to the data is performed by the flash memory controller 15. This means that such a process as to inhibit a real-time property of the data is omitted. Therefore, this becomes effective in avoiding a failure in the system due to the fact that the effective record rate falls below the rate for the write data.

Another example will next be explained.

The processes executed by the flash memory system 1 and the interface controller 2 shown in FIGS. 1 and 2 can be changed as follows.

The memory control unit 14 has a first write mode accompanied by rewriting of the same data upon the write operation for the memory unit 11, and a second write mode unaccompanied by it. The interface controller 2 has a flash memory controller 15. In the case of writing for the data area 13, the flash memory controller 15 instructs the memory control unit 14 to perform write control in the second write mode. In the case of writing for the management area 12, the flash memory controller 15 instructs the memory control unit 14 to perform write control in the first write mode. At this time, the instructions for the write control in the first write mode and the instructions for the write control in the second write mode are supplied from the controller to the memory control unit 14 via the input/output terminal I/O for enabling capturing of write addresses and write data according to predetermined commands, in advance of the write addresses and write data.

Incidentally, in the flash memory controller 15, the omission of addition of a code for correcting an error of data to be written into the data area from the data, and the addition of a code for correcting an error of data to be written into the management area to the data, and other processes are similar to the above embodiment. Therefore, their detailed description will be omitted.

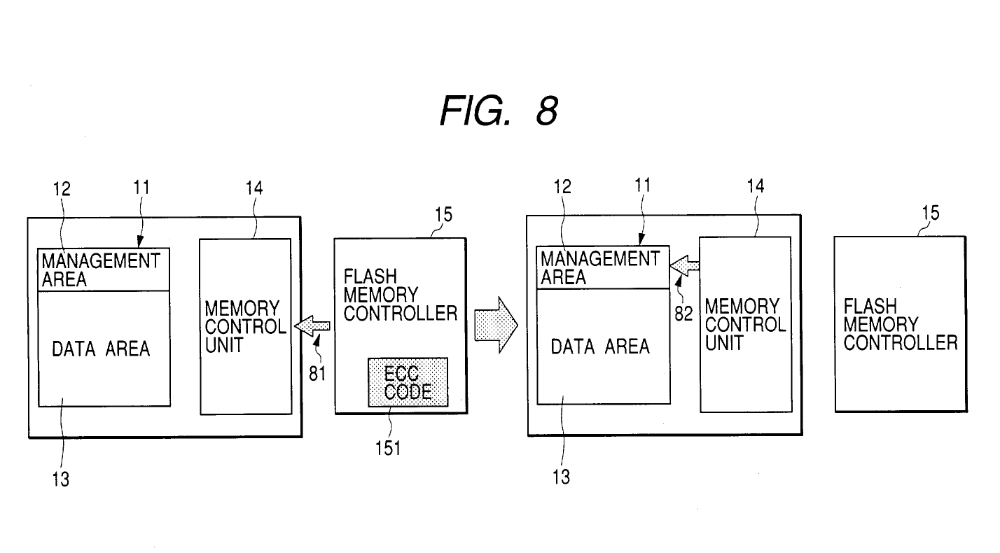

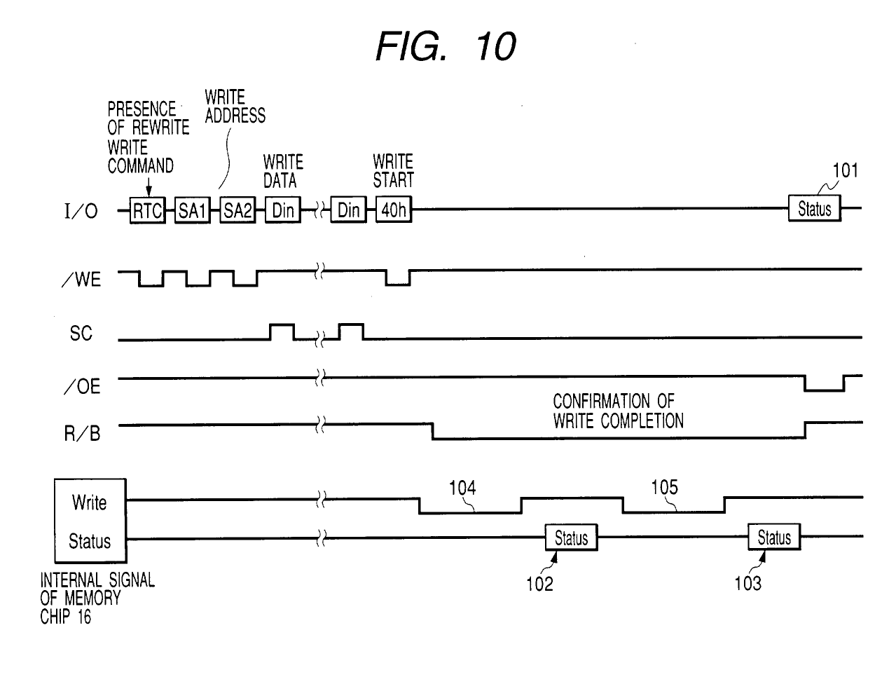

The operation of writing to the management area 12 is shown in FIG. 8, and operating timings of major parts at the write operation are illustrated in FIG. 10.

When management information is written into the management area 12, the flash memory controller 15 generates an ECC code 151 and issues an access command to the memory control unit 14 so that data is written into the management area together with the code (81). At this time, a write command RTC with retry, write addresses SA1 and SA2, write data Din and a write start command 40h are sequentially transmitted to the corresponding input/output terminal I/O of the flash memory system 1 from the flash memory controller 15 as shown in FIG. 10. The write command RTC with retry is set as a command for designating or instructing a first write mode accompanied by rewriting of the same data upon a write operation for the memory unit 11. Since such a command is supplied from the flash memory controller 15 to the memory control unit 14, the writing to the management area 12 is performed in the first write mode (82). The write address SA1 is set as a row address signal of the memory unit 1. The write address SA2 inputted following it is set as a column address signal of the memory unit 1. The write address SA2 is set as an initial address for memory access, and an address following it is generated by the memory control unit 14 in synchronism with a serial clock signal SC transmitted from the flash memory controller 15. The write data Din transmitted to the input/output terminal I/O is taken in or brought to the memory control unit 14 in synchronism with the serial clock signal SC. Writing is performed in response to the write start command 40h. The writing to the management area 12 is performed during a period in which a ready/busy signal R/B is low in level. During the period in which the ready/busy signal R/B is low in level, first writing is carried out during a period in which an internal write signal Write outputted from the memory control unit 14 is asserted low in level. The memory control unit 14 makes a decision as to the logic of a predetermined bit in internal status information (Status) 102. When it is determined upon such logic determination that a write error has occurred, the memory control unit 14 performs rewriting of the same data into the management area 12 and determines the logic of a predetermined bit in internal status information (Status) 103 again. When it is judged upon such logic determination that no write error has occurred, the memory control unit 15 brings the ready/busy signal R/B to a high level. Thus, the flash memory controller 15 recognizes the completion of writing to the management area 12 and asserts an output enable signal/OE low in level. Consequently, a status signal (Status) 101 is outputted from the input/output terminal I/O, and hence the flash memory controller 15 is capable of recognizing the state of the flash memory system 1 in response to the status signal (Status) 101.

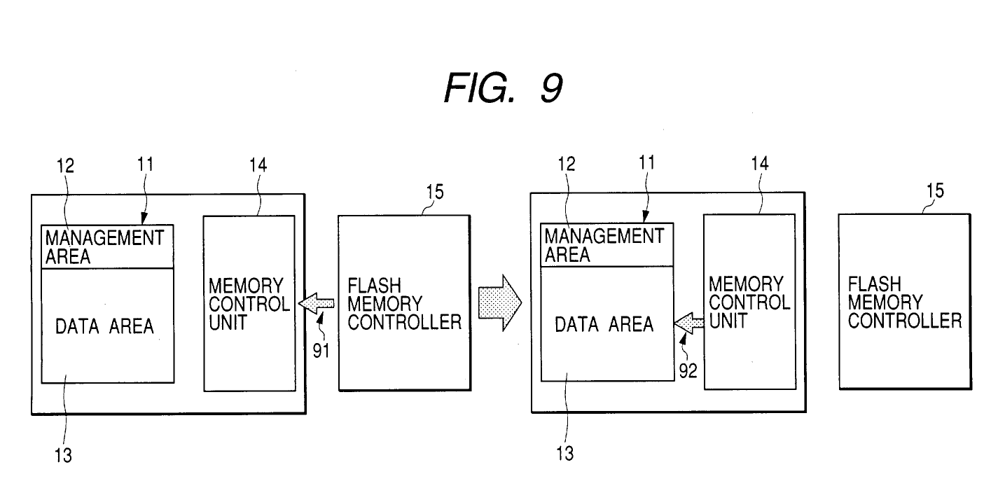

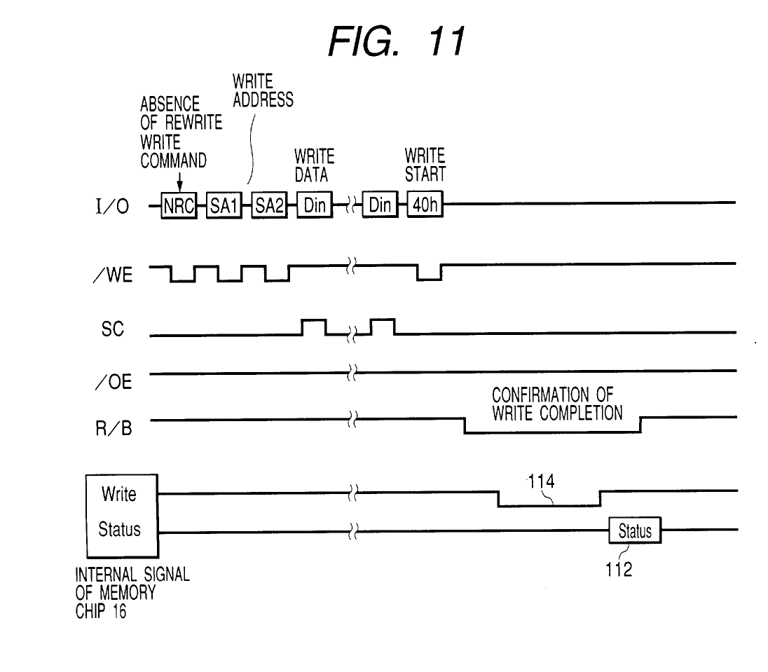

The operation of writing to its corresponding data area 13 is shown in FIG. 9, and operating timings of major parts at the write operation are illustrated in FIG. 11.

When data is written into the data area 13, the flash memory controller does not create an ECC code and issues an access command to the memory control unit 14 so as to write only the data into the data area 13 (91). At this time, a write command NRC with no retry, write addresses SA1 and SA2, write data Din, and a write start command 40h are sequentially transmitted from the flash memory controller 15 to the input/output terminal I/O of the flash memory system 1 as shown in FIG. 11. The retry-free write command NRC is set as a command for specifying or instructing a second write mode unaccompanied by rewriting of the same data upon a write operation for the memory unit 11. Owing to the supply of such a command from the flash memory controller 15 to the memory control unit 14, the writing of the data into the data area 13 is performed in the second write mode (92). The write address SA1 is set as a row address signal of the memory unit 1, and the write address SA2 inputted following it is set as a column address signal of the memory unit 1. The write address SA2 is set as an initial address for memory access, and an address following it is generated by the memory control unit 14 in synchronism with a serial clock signal SC transmitted from the flash memory controller 15. The write data Din transmitted to the input/output terminal I/O is taken in the memory control unit 14 in synchronism with the serial clock signal SC. Further, the writing is done in response to the write start command 40h. The writing to its corresponding management area 12 is performed during a period in which a ready/busy signal R/B is low in level. During the period in which the ready/busy signal R/B is low in level, the writing of data therein is performed during a period in which an internal write signal Write outputted from the memory control unit 14 is asserted low in level. While internal status information (Status) 112 is generated at this time, error determination based on determination as to the logic of a predetermined bit in this information is not performed. Namely, the data writing is completed regardless of the contents of the internal status information (Status) 112. This is because a real-time property of data is given priority and such a process as to inhibit the real-time property of the data is omitted as far as practicable.

According to the above-described example, the following operations and effects can be obtained.

(1) The memory control unit 14 includes a first write mode accompanied by the rewriting of the same data upon the write operation for the memory unit 11, and a second write mode unaccompanied by it. In the case of the writing to the data area 13, the flash memory controller 15 instructs the memory control unit 14 to perform write control in the second write mode. In the case of the writing to the management area 12, the flash memory controller 15 instructs the memory control unit 14 to perform write control in the first write mode. Thus, the writing of next data is instructed to a write error produced in the data area without instructing the rewriting of the same data. Therefore, a write speed of a predetermined rate or more is assured in a manner similar to the above example, whereby an effective record rate can be avoided from falling below a rate for write data. Instructing the rewriting of the same data with respect to a write error produced in the management area makes it possible to assure the accuracy for performing data writing in the management area.

(2) The addition of a code used for correcting an error of data to be written into the data area to the same data is omitted in the flash memory controller 5. A code for correcting an error of data to be written into the management area is added to the same data. Thus, such a process as to give priority to a real-time property of the data and inhibit the real-time property thereof can be omitted as far as practicable. Therefore, a write speed of a predetermined rate or more is assured to thereby make an effective record rate effective in avoiding that it falls below a rate for write data.

(3) Instructions for write control in the first write mode and instructions for write control in the second write mode are supplied to the memory control unit 14 via a terminal for enabling capturing of write addresses and write data according to predetermined commands, in advance of the write addresses and write data. It is thus possible to smooth a process based on such instructions as referred to above.

(4) The addition of a code for correcting an error of data to be written into the data area 13 is omitted from the same data, whereas a code for correcting an error of data to be written into the management area 12 is added to the same data. Thus, since such a process as to give priority to a real-time property of data and inhibit the real-time property can be omitted as far as practicable, an effective record rate becomes effective in avoiding that it falls below a rate for write data.

While the invention made above by the present inventors has been described specifically, the present invention is not limited to it. It is needless to say that various changes can be made thereto within the scope not departing from the substance thereof.

While the above description has principally been made of a data recording system that belongs to the field of application corresponding to the background of the invention, the present invention is not limited to it. The present invention can be applied to various nonvolatile memories.

The present invention can be applied under the condition that at least a data area that enables the writing of data and a management area capable of writing therein management information about the data written into the data area are included.

Advantageous effects obtained by a typical one of the inventions disclosed in the present application will be explained in brief as follows:

The writing of next data is instructed to a write error produced in a data area without designating the rewriting of the same data. Therefore, a write speed of a predetermined rate or more is assured, so that an effective record rate is avoided from falling below a rate for write data. Owing to it, it is possible to avoid a failure in the system due to the fact that the effective record rate in the system falls below the rate for the write data. Instructing the rewriting of the same data with respect to a write error produced in the management area makes it possible to assure the accuracy for performing writing in the management area.

What is claimed is:

1. A nonvolatile memory, comprising:
a memory unit including a data area capable of writing data therein and a management area capable of writing therein management information about the data written into the data area;
a memory control unit for controlling the operation of said memory unit; and
control means for instructing writing of next data with respect to a write error produced in the data area without instructing rewriting of the same data and for instructing rewriting of the same data with respect to a write error produced in the management area.

2. A nonvolatile memory, comprising:
a memory unit including a data area capable of writing data therein, and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory control unit transmits error information to said memory controller without rewriting when an error occurs upon the writing to said memory unit, and
wherein said memory controller controls writing of next data without rewriting of the same data when a write operation at the transmission of error information from said memory control unit is intended for the data area, and controls rewriting of the same data when the write operation at the transmission of the error information from said memory control unit is intended for the management area.

3. A nonvolatile memory, comprising:
a memory unit including a data area capable of writing data therein, and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory control unit transmits error information to said memory controller without executing rewriting when a write error is produced in said memory unit, and
wherein said memory controller omits addition of a code for correcting an error of data to be written into the data area to the data and adds a code for correcting an error of data to be written into the management area to the data, and controls writing of next data without executing rewriting of the same data when a write operation at the transmission of the error information from said memory control unit is intended for the data area, and controls rewriting of the same data when the write operation at the transmission of the error information from said memory control unit is intended for the management area.

4. A nonvolatile memory, comprising:
a memory unit including a data area capable of writing data therein and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory controller issues a first command for specifying a first write mode accompanied by rewriting of the same data upon the writing to the management area, and issues a second command for specifying a second write mode free of rewriting of the same data upon the writing to the data area, and
wherein said memory control unit does not effect rewriting of the same data on a write error in the second write mode and effects rewriting of the same data on a write error in the first write mode.

5. A nonvolatile memory, comprising:
a memory unit including a data area capable of writing data therein and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory controller issues a first command for specifying a first write mode accompanied by rewriting of the same data upon the writing to the management area and issues a second command for specifying a second write mode free of rewriting of the same data upon the writing to the data area, and omits addition of a code for correcting an error of data to be written into the data area to the data and adds a code for correcting data to be written into the management area to the data, and
wherein said memory control unit does not effect rewriting of the same data on a write error in the second write mode and effects rewriting of the same data on a write error in the first write mode.

6. A nonvolatile memory, comprising:
a memory unit including a data area capable of writing data therein and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory controller issues a first command for specifying a first write mode accompanied by rewriting of the same data upon the writing to the management area and issues a second command for specifying a second write mode free of rewriting of the same data upon the writing to the data area,
wherein said memory control unit does not effect rewriting of the same data on a write error in a specified state of the second write mode and effects rewriting of the same data on a write error in the first write mode, and
wherein said first command and said second command are supplied to said memory control unit via a terminal for enabling capturing of write addresses and write data, in advance of the write addresses and the write data.

7. A nonvolatile memory, comprising:
a memory unit including a data area capable of writing data therein and a management area capable of writing therein management information about the data written into the data area;
a memory controller capable of issuing various commands related to the operation of said memory unit; and
a memory control unit for controlling the operation of said memory unit according to a command issued from said memory controller,
wherein said memory controller issues a first command for specifying a first write mode accompanied by rewriting of the same data upon the writing to the management area and issues a second command for specifying a second write mode free of rewriting of the same data upon the writing to the data area, and omits addition of a code for correcting an error of data to be written into the data area to the data and adds a code for correcting data to be written into the management area to the data,
wherein said memory control unit does not effect rewriting of the same data on a write error in the second write mode and effects rewriting of the same data on a write error in the first write mode, and
wherein said first command and said second command are supplied to said memory control unit via a terminal for enabling capturing of write addresses and write data, in advance of the write addresses and the write data.

8. The nonvolatile memory according to claim 1, wherein the data written into the data area is used as motion picture data or voice data.

9. The nonvolatile memory according to claim 8, wherein said memory unit comprises one or more nonvolatile memories, and said memory control unit comprises a controller.

10. The nonvolatile memory according to claim 2, wherein the data written into the data area is used as motion picture data or voice data.

11. The nonvolatile memory according to claim 10, wherein said memory unit comprises one or more nonvolatile memories, and said memory control unit comprises a controller.

12. The nonvolatile memory according to claim 3, wherein the data written into the data area is used as motion picture data or voice data.

13. The nonvolatile memory according to claim 12, wherein said memory unit comprises one or more nonvolatile memories, and said memory control unit comprises a controller.

14. The nonvolatile memory according to 3, wherein the data written into the data area is used as motion picture data or voice data.

15. The nonvolatile memory according to claim 14, wherein said memory unit comprises one or more nonvolatile memories, and said memory control unit comprises a controller.

16. The nonvolatile memory according to claim 4, wherein the data written into the data area is used as motion picture data or voice data.

17. The nonvolatile memory according to claim 16, wherein said memory unit comprises one or more nonvolatile memories, and said memory control unit comprises a controller.

18. The nonvolatile memory according to claim 5, wherein the data written into the data area is used as motion picture data or voice data.

19. The nonvolatile memory according to claim 18, wherein said memory unit comprises one or more nonvolatile memories, and said memory control unit comprises a controller.

20. The nonvolatile memory according to claim 6, wherein the data written into the data area is used as motion picture data or voice data.

21. The nonvolatile memory according to claim 20, wherein said memory unit comprises one or more nonvolatile memories, and said memory control unit comprises a controller.

22. The nonvolatile memory according to claim 7, wherein the data written into the data area is used as motion picture data or voice data.

23. The nonvolatile memory according to claim 22, wherein said memory unit comprises one or more nonvolatile memories, and said memory control unit comprises a controller.

24. A nonvolatile memory, comprising:
one or more nonvolatile memories; and
a controller,
wherein said controller performs write control for writing externally-supplied data into said one or more nonvolatile memories, and
wherein said write control has first write control which rewrites data when a write error occurs due to the writing of the data, and second write control which unrewrites data when a write error occurs due to the writing of the data.

25. The nonvolatile memory according to claim 24, wherein said controller issues any one of a first write command for instructing the first write control and a second write command for instructing the second write control to said one or more nonvolatile memories.

26. The nonvolatile memory according to claim 25, wherein said controller instructs the first write control when management information is written into said one or more nonvolatile memories, and
wherein said controller instructs the second write control when information including image information or voice information is written into said one or more nonvolatile memories.

27. The nonvolatile memory according to claim 26, wherein the rewriting of the data is effected on an area identical to an area in which a write error has occurred in said one or more nonvolatile memories.

28. The nonvolatile memory according to claim 26, wherein the rewriting of the data is effected on an area different from the area in which the write error has occurred in said one or more nonvolatile memories.
